(19) United States
(12) Patent Application Publication
(10) Pub. No.: US 2009/0319478 A1
(43) Pub. Date: Dec. 24, 2009

(54) METHOD FOR IMPROVING THE PERFORMANCE OF A FILE SYSTEM IN A COMPUTING DEVICE

(75) Inventors: Guillaume Proux, Tokyo (JP); WillIam Roberts, London (GB)

Correspondence Address: Saul Ewing LLP (Philadelphia), Attn: Patent Docket Clerk, 2 North Second St., Harrisburg, PA, 17101, US

(73) Assignee: SYMBIAN SOFTWARE LIMITED, London (GB)

(21) Appl. No.: 11/571,023

(22) PCT Filed: Jun. 22, 2005
(86) PCT No.: PCT/GB2005/002464

§ 371 Date: Jun. 9, 2009

(30) Foreign Application Priority Data
Jun. 24, 2004 (GB) 0414138.8

(51) Int. Cl. G06F 17/30

(52) U.S. Cl. 707/3; 707/7; 707/E17.01; 707/E17.014

(57) ABSTRACT

A computing device filesystem is provided with separate presorted arrays of pointers to subdirectory and file entries along with the standard unsorted and mixed flat file lists which comprise directories in filesystems such as FAT. When included in boot ROMs on mobile battery operated devices, this enables a much shorter interval between power-on and the device reaching operational state (faster boot time) because it is no longer necessary to navigate through multiple layers of the directory tree and searching every entry in each branch for a matching filename. The new presorted arrays allow for matching entries to be located more efficiently by means of a simple binary search.

The present invention relates to a method for improving the performance of a file system in a computing device, and in particular to improving such a system in a mobile battery-operated computing device, thereby enabling a faster boot time than has previously been available with this type of device.

The term computing device as used herein is to be expansively construed to cover any form of electrical computing device and includes, data recording devices, computers of any type or form, including hand held and personal computers, and communication devices of any form factor, including mobile phones, smart phones, communicators which combine communications, image recording and/or playback, and computing functionality within a single device, and other forms of wireless and wired information devices.

Files on computing devices are persistent named data stores, presented as a single stream of bits. File management is one of the major tasks of operating systems for all but the simplest computing devices. In the early days of stand-alone personal computers, file management was arguably the main operating system task, as is shown by Microsoft's choice of the acronym DOS (Disk Operating System) for their first operating system. While user interfaces have become more complex, and the growth of networked and connected systems and the convergence of computing and telecommunications devices has increased, the importance of network and link management, and file management still remains one of the functions at the core of any advanced computing device.

The most basic file management tasks in modern operating systems are
keeping a directory or index of files on the system
opening or creating named files on request
enabling content to be read and written.
enabling deletion of files or content
   The part of the operating system which looks after file management is called the filesystem.

As well as the file management tasks described above, the filesystem typically takes care of other tasks. Some of these are consequential on the basic tasks; for instance, keeping track of spare file space on the system and allocating it on demand is, in essence, essential for all modern disk-based systems. Other tasks are contingent on the nature of the device the filesystem is running on; for example, while many filesystems implement security measures which restrict access to specific files, this is something that is only really necessary in networked and multi-user environments. It should also be noted that it is usual for computing devices to support multiple different types of filesystems for different media types; for example, modern computers running Microsoft Windows XP typically support NTFS (NT File System) filesystem for hard disks, various versions of FAT (File Allocation Table) for floppy disks, and ISO9600 with its various extensions for CD (compact disk) and DVD (digital video disk) drives.

For a summary of the many families of filesystems in use today and details of the way that they work and the differences between them, reference is made to
http://en.wikipedia.org/wiki/File_system
or http://www.tldp.org/HOWTO/Filesystems-HOWTO.html,
   which both list over 40 examples of this art.

It should be noted in particular that all these different filesystems have different combinations of strengths. A person skilled in this art would not reasonably claim a particular filesystem as being the best in all circumstances, because although the criteria by which all filesystems can be judged include resilience and reliability, security, speed, flexibility, efficiency, size and ubiquity, the relative importance of these in any specific context will vary.

The context in which this invention is particularly applicable is that of a filesystem used to boot up an operating system stored in read-only memory (ROM) on a battery-powered handheld mobile computing device, such as a cellular telephone.

It will be appreciated that this is a relatively specific context and a number of the criteria listed above for evaluating filesystems do not apply. For example, in normal use a filesystem for a ROM is completely static; its contents never change, and by definition it is read-only and nothing can be written to it. Therefore there is not the same danger of corruption as on a write-enabled medium, and however important considerations of resilience, reliability and security may be for writable filesystems, they cannot be accounted as significant for a ROM filesystem.

There are many other considerations affecting the design of generic filesystems that do not apply to ROM filesystems. Some of these arise from the fact that ROM filesystems cannot be written to; for instance, there is no concern about fragmentation of files on the physical media in a read-only filesystem. Others arise from the fact that ROM filesystems are solid state; so speed optimisations which derive their effectiveness from the avoidance of large movements of read-write heads would make no difference to a ROM filesystem.

On the other hand, there are specific considerations which assume much greater significance for filesystems used in mobile battery-powered devices. The most obvious derive from the fact that such devices are necessarily resource constrained. Because they are powered by batteries for most operations, they need to be economical regarding power consumption. And, because they have only limited amounts of memory, in comparison to PC type computing devices, they need to conserve what memory they do have to the maximum extent possible. So, application programs to run on such devices should be designed to be as compact as possible.

A third constraint can be derived from the first two; given the requirement for a small memory footprint, it would clearly be desirable if the same filesystem could be used both for the ROM filesystem and also for any writable filesystem on the device. A single filesystem is simpler to implement and uses less memory than multiple filesystems. However, mobile battery-operated devices are increasingly being provided with removable storage devices such as Compact Flash cards, Memory Sticks, Multimedia cards and Secure Digital cards. They are now commonplace on devices such as digital cameras and handheld PDAs (personal digital assistants), and are becoming increasingly commonplace on mobile phones. There is a clear benefit to users if the common single filesystem used by the device ROM and also by the device when running applications could be a ubiquitous industry-standard one, as this would enable a user to use the peripheral storage on one such device for data transfer and backup on another type of device.

A fourth constraint affecting this class of device is that it needs to become operational after power-up as quickly as possible (minimal boot time). For example, in the case of a cellular phone, users in general find it intolerable if they have to wait for three or four minutes between switching on their phone and being able to make a call.

To summarise, therefore, the following are the important criteria for a filesystem to be used on the boot ROM of a battery-powered handheld mobile computing device such as a cellular telephone:
Economical power consumption
Small memory footprint
Compatibility with industry standards
Fast boot time

This invention is primarily concerned with the final criterion, that of fast boot time. It should be noted that while cellular phones devices are the main target of the invention, the consideration listed above apply equally to many other portable computing devices such as PDAs and indeed, any portable devices (such as digital cameras) that include operating systems with file management functionality.

Boot-up time in general is a factor which most filesystem authors have not considered to be of primary importance; performance post-boot has, to date, generally been considered to be more important.

Certain literature has discussed the issue of startup speeds but, as will be appreciated by the person familiar with this art, this is not quite the same thing as boot-up time. For example, it is well known that journaling filesystems such as NTFS (for Windows) and ext3 or ReiserFS (for Linux) permit faster startup after a system crash than filesystems based on FAT (for Windows) and ext2 (for Linux) because they do not need to scan the whole file store to assure the integrity of the filesystem. However, the specific problems of restarting a filesystem after a crash all involve how the integrity of the filesystem metadata can be checked; and since a ROM filesystem does not really have to worry about this type of corruption, journaling optimisations cannot have any effect on boot speed. They are in the same category as those filesystem optimisations which increase speed of file loading by decreasing physical fragmentation in the file store, which, as we have already pointed out, have no effect on a ROM filesystem because it never becomes fragmented in the first place.

Even where a filesystem does include optimisations that improve boot-up times, these have not been designed specifically for ROM based filesystems. For example, the optimizations included in YAFFS (Yet Another Flash Filing System, described at http://www.aleph1.co.uk/yaffs/) are specifically designed to cope with the unique characteristics of NAND flash hardware rather than the algorithms of booting from a ROM.

In general, software optimisations generally begin by looking for inefficient operations that are either repeated multiple times or have the potential to be involved in loops, and then either remove the efficiency in the implementation of the action, or short-circuit the loop, or both.

The most notable set of such operations for the purposes of optimising boot time in a ROM filesystem are those that are carried out on entries in its directories and subdirectories in order to retrieve a file located somewhere on a filesystem.

Filesystems generally store pointers to files and directories in a logically hierarchical directory structure. In such a structure, a single root directory is always the initial place where file retrieval begins; the root directory may point to other directories as well as to files, and each of the directories it contains may also point to other directories as well as to files. A fully qualified filename consists of the file name, prefixed by the subdirectory in which the file is found, which is in turn prefixed by the directory in which that subdirectory is found, and so on back to the root directory.

In order to locate a file, the filesystem, when given such a filename, has to
1) parse the string representing the filename into its path and file components
2) navigate through the path inside the directory tree until matches are found, first for the path components and then for the file name
3) retrieve the file attributes, including the physical location of the file.

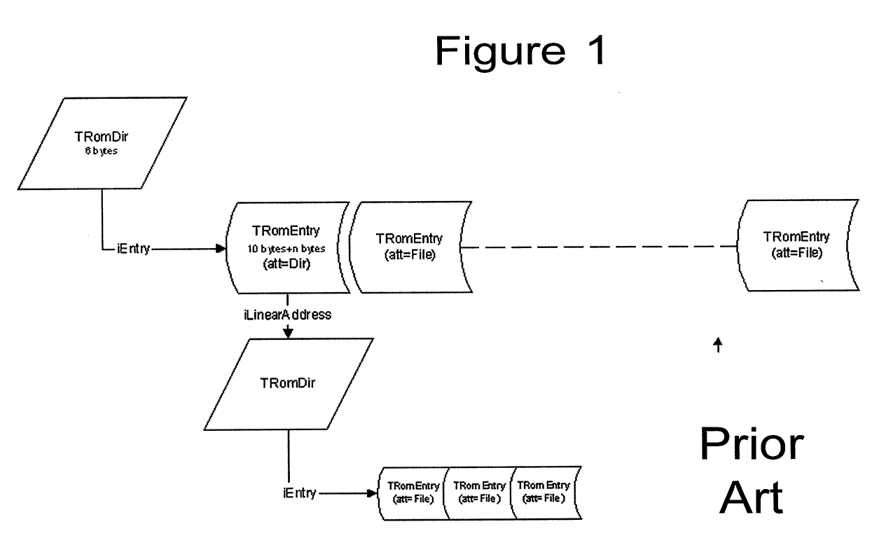

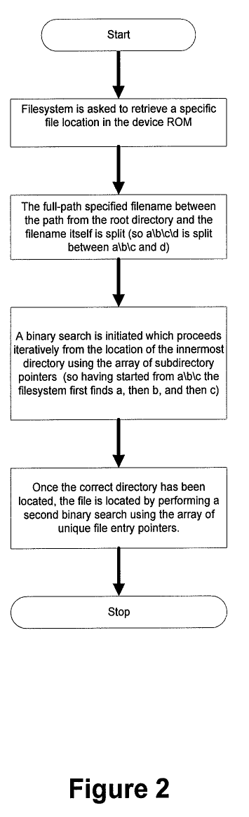

A typical implementation of this process based on the widely implemented FAT filesystem (note that the term FAT is intended to include such common industry variants as VFAT and FAT32; for more information see http://en.wikipedia.org/wiki/FAT32#Versions_and_history) is shown in FIG. 1, using idioms from the Symbian OS™ operating system, the advanced mobile phone operating system from Symbian Software Ltd of London. In the filesystem of FIG. 1, the TRomDir objects correspond to the branches in a directory tree. They contain an array of an indeterminate number of TRomEntry objects, which correspond to the directory entries. Because of the way the filesystem works, these objects are themselves of varying sizes; furthermore, some TRomEntry objects may point to further TRomDir objects while others may represent actual files.

Since this operation is necessary before each file is loaded, it is repeated many times. It would therefore be a suitable place to look for optimisations in filesystem performance; but it is evident that because the operation is repeated before each file is loaded, there are inefficiencies in the algorithm used. Thus, it makes the time taken to locate and open files unpredictable. In the worst cases, many branches and links need to be explored and many text string comparisons need to be made before a file can be opened. These comparisons can be quite expensive in terms of processing time, particularly when a filesystem supports Unicode filenames, and can therefore give rise to extended boot times.

The inherent problems with this type of filesystem would not be apparent when accessing a ROM which included only a few files and did need to support Unicode. However, modern operating systems for mobile devices which require Unicode filenames and need to manage a large number of files in a large number of directories reveal the inadequacies of this filesystem by manifesting relatively long boot times.

It is true that the particular case described above is applicable primarily to filesystems that rely on linked lists (such as FAT or ext2), and that there are a number of journaling filesystems (such as ReiserFS or NTFS) that sort directory entries into B-Trees, in which case the number of iterations to find a file may already be already optimised.

However, any suggestion of solving the problem simply by moving to one of these more heavyweight filesystems must be considered purely academic: the constraints affecting mobile battery operated devices described earlier make the case of FAT based systems the most important single filesystem to consider. Some of the reasons for this are
FAT offers something close to the minimum functionality for a filesystem and hence it is relatively efficient in terms of power consumption.
FAT filesystems use relatively small amounts of memory.
FAT is the industry standard leader in terms of interoperability. It is supported by the major desktop operating systems, including all versions of Windows and Linux, and is the standard filesystem used for the various types of removable media on, for example, mobile phones, digital cameras and PDAs.

While FAT cannot be considered perfect (its deficiencies are well known), it can be seen that the majority of these deficiencies are not of particular significance for ROM based filesystems. Ways of optimising such filesystems for faster bootup would therefore offer great benefits to almost all users.

It is therefore an object of the present invention to provide an improved file management system for a computing device.

According to a first aspect of the present invention there is provided a method of operating a filesystem for a computing device having a directory structure recursively representing the content of any directory of the structure by means of an unsorted list of directory entries; the method comprising including after the said list of entries a counted and sorted first array of pointers to all the entries contained in each directory which correspond to subdirectories, or a pointer to the first array; and conducting a binary search across the first array for enabling the location of any directory to be obtained, or its absence to be confirmed.

According to a second aspect of the present invention there is provided a computing device arranged to operate in accordance with a method according to the first aspect.

According to a third aspect of the present invention there is provided an operating system for a computing device for causing the device to operate in accordance with a method of the first aspect.

An embodiment of the present invention will now be described, by way of further example only, with reference to the accompanying drawing which shows an example of a filesystem based on the FAT filesystem.

The present invention is predicated on the basis that an underlying concern with a FAT filesystem is that the system consists of a series of linked lists which have a number of sub-optimal characteristics which slow down the time taken to locate and load files, and therefore slow down the time taken for a device utilising the system to boot up. It should be noted that while the specific case of FAT filesystems forms the basis of the embodiment described below, the invention is in fact applicable to any filesystem in which file location requires the navigation and searching of a series of linked lists. The sub-optimal characteristics that such systems share are as follows:
File and directory entries can be arbitrarily mixed
File and directory entries are essentially unsorted
File and directory entries are not guaranteed to be of a fixed size.

For reasons given above, it is neither practical nor desirable to dispense with the FAT filesystems completely; neither is it worthwhile to introduce a completely different filesystem for a boot ROM. Therefore, this invention is based on the introduction of extensions to existing FAT filesystems specifically designed to improve boot time while at the same time retaining full compatibility with the FAT filesystem specifications.

The most significant of these extensions are to include in each directory one sorted list of all the subdirectory entries which each directory contains, and a second sorted list of all the unique file entries which it contains. The sorted lists are kept in a form such as an array, which enables a simple binary search algorithm to locate a file from a fully qualified pathname. A binary search of such a sorted array uses the name of the item being searched for as a key, and starts by taking the whole array as the interval and looking at the item pointed at by the entry in the middle of the array. Using the same collating technique as is used to sort the list initially, the name in this entry is compared to the search key. If this name is greater than the key, the interval is narrowed to one half (e.g. the upper half) of the list, while if it is less, the interval is narrowed to the other half (e.g. the lower half) of the list. This process is repeated using the new interval until either the key matches the name or the interval reaches zero.

A binary search of this type is highly efficient to implement and is comparable in speed to the location of files enabled by journalled filesystems such as ReiserFS and NTFS which keep their entries in balanced trees (B-Trees). But, because the filesystem is for a ROM and these lists are therefore guaranteed to be static, they can be included in the ROM during manufacture and impose none of the extra run-time overheads associated with maintaining B-Trees. By locating these sorted lists after the normal entries in each directory full compatibility with existing file FAT filesystems can be assured.

The ROM filesystem represents the content of any directory recursively by the means of a flat list of directory entries, which conforms with the standard format for FAT-compatible filesystems. With the present invention, the standard ROM filesystem is accelerated by adding two arrays (in the form of a count and a list of memory offsets) after the filesystem data, enabling old components in the filesystem to maintain compatibility with previous systems. The first of these arrays keeps a sorted list of pointers to all subdirectory entries in the directory and the second array keeps a sorted list of pointers to all file entries in the directory. Searching through a sorted array is made using a typical binary search optimised for the current use case. For each iteration of the binary search, identification of the correct entry is attempted by means of a quick locale-agnostic comparison function of Unicode strings; all Unicode characters in the ASCII range (below 128) are folded, i.e. characters with the same ASCII values are treated as identical, while all others are left unchanged. As a further optimisation, as would be permitted by most computing device operating systems, characters in the ranges A-Z and a-z may be considered equivalent.

With the present invention, when the filesystem is asked to retrieve a specific file location in the device ROM, the following steps are followed:
the full-path specified filename between the path from the root directory and the filename itself is split (so a\b\c\d is split between a\b\c and d). This is referred to as step “S”.
A binary search is initiated which proceeds iteratively from the location of the innermost directory using the array of subdirectory pointers described above (so having started from a\b\c the filesystem first finds a, then b, and then c). This is referred to as Step “L”.
Once the correct directory has been located, the file is located by performing a second binary search using the array of unique file entry pointers described above. This is referred to as Step “F”.

Once the basic mechanism of pre-sorted arrays of pointers to subdirectories and to file entries is in place, a number of further optimisations then become possible. Three examples of such optimisations are:

### Wildcard Searches

The invention can also accelerate the location of sets of files which include wildcards in the file names (for example, where the ‘?’ character represents a single character and the ‘*’ character represents one or more characters). In such cases, the accelerated directory lookup happens as described above in step “L”. If the wildcards occur at the start of the filename, then it is not possible to optimise the search further, and the filesystem falls back to a generic wildcard matching facility.

However, if the wildcards occur at the end of a string, then the array of unique file pointers will enable files to be sequentially matched from the first file in the sorted array having a matching prefix string is found until the first file not matching the prefix string is found, and the files matched to the string including the wildcards can be returned directly in a sequential pre-sorted manner. This is especially beneficial in large directories.

As a special case of the above, if the wildcard character ‘*’ occurs in isolation, denoting all files in the current directory, then the array of unique file entry pointers enables all files in the current directory to be returned in a sequential pre-sorted manner.

### Directory Path Cache

This is a variation of step “L” above.

A cache can be used to maintain the locations of recently needed file paths. This is especially beneficial at boot time when very many files are read from directories reserved for system libraries, such as \sys\bin in Symbian OS, \winnt\system32 in Windows, and /lib or /bin in Linux. Such a cache can typically save many time consuming comparison operations. Those skilled in the art of building boot ROMs and profiling their operation will readily appreciate how to select the most appropriate cache size that minimises the cache maintenance overhead and maximises the cache hit rate.

### Fixed Path Cache

This is another variation of step “L” above.

At ROM build time, the most used deep paths inside the ROM filesystem can be preinstalled in a ROM cache. Once again, those skilled in the art of building boot ROMs and profiling their operation will readily appreciate how to identify the best path candidates. This optimisation can of course be combined with the ‘Directory Path Cache’ to further improve performance.

The key advantage of this invention is that it significantly reduces the time taken to boot up a computing device without requiring the implementation of a secondary filesystem and without impairing compatibility with the industry standards based on FAT filesystems. Therefore, this invention enables fast booting on computing devices, and particularly on mobile computing devices, without incurring memory or run-time penalties which might arise from alternative solutions.

Thus, this invention provides a method and device which includes separate presorted arrays of pointers to subdirectory and file entries along with the standard unsorted and mixed flat file lists which comprise directories in systems such as FAT. When included in boot ROMs on mobile battery operated devices, this enables a much shorter interval between power-on and the device reaching operational state (faster boot time). This is because it is no longer necessary to navigate through multiple layers of the directory tree and searching every entry in each branch for a matching filename; the new presorted arrays allow for matching entries to be located more efficiently by means of a simple binary search.

Although the present invention has been described with reference to particular embodiments, it will be appreciated that modifications may be effected whilst remaining within the scope of the present invention as defined by the appended claims.

1. A method of operating a filesystem for a computing device having a directory structure recursively representing the content of any directory of the structure by means of an unsorted list of directory entries; the method comprising including after the said list of entries a counted and sorted first array of pointers to all the entries contained in each directory which correspond to subdirectories, or a pointer to the first array; and conducting a binary search across the first array for enabling the location of any directory to be obtained, or its absence to be confirmed.

2. A method according to claim 1 further comprising including after the list of directory entries a counted and sorted further array including pointers to all the entries contained in each directory which correspond to files, or a pointer to the further array; and conducting a binary search across the said further array for enabling either the location of any named file to be obtained, or its absence to be confirmed.

3. A method according to claim 2 comprising conducting a wildcard search for a file by comparing a wildcard character against all or part of the file entries pointed at by the further array, and returning filenames having correspondence with the wildcard character in a sequential pre-sorted manner by stepping through any portion of the array matching the wildcard character.

4. A method according to claim 1 comprising using a cache to maintain locations of file paths identified by the first array.

5. A method according to claim 1 further comprising conducting the binary search using a locale-independent comparison algorithm for Unicode strings whereby all characters in the ASCII range are folded.

6. A method according to claim 1 wherein the filesystem is for a read-only medium.

7. A method according to claim 6 wherein the first array is arranged to be located within the filesystem.

8. (canceled)

9. A method according to claim 6 wherein the filesystem is arranged to comprise a cache of file paths previously profiled as the most frequently used filepaths.

10. A method according to claim 1 wherein the filesystem is arranged to comprise a filesystem for a boot device.

11. A computing device arranged to operate in accordance with a method as defined in claim 1.

12. An operating system for a computing device for causing the computing device to operate in accordance with a method as defined in claim 1.

13. A method according to claim 2 wherein the filesystem is for a read-only medium and wherein the further array is arranged to be located within the filesystem.
